(19) United States
(12) Patent Application Publication
(10) Pub. No.: US 2011/0313974 A1
(43) Pub. Date: Dec. 22, 2011

(54) PRIORITIZED DATA BACKUP

(75) Inventor: Ningyi CHEN, Beijing (CN)

(73) Assignee: Computer Associates Think, Inc., Islandia, NY (US)

(21) Appl. No.: 12/817,934

(22) Filed: Jun. 17, 2010

(51) Int. Cl. G06F 17/00; G06F 12/16

(52) U.S. Cl. 707/654; 707/640; 707/E17.01

(57) ABSTRACT

A prioritized data backup may be performed. Source data elements may by associated with local properties such as a base priority indicator and a current priority indicator. A base priority indicator associated with a given data element may convey the importance of that data element. The source data elements may be sorted into an order based on current priority indicators associated with individual ones of the source data elements. Source data elements associated with current priority indicators greater than or equal to a priority threshold may be backed up according to the order. Additional source data elements may be backed up according to the order when time remains in a backup window.

### FIELD OF THE INVENTION

The invention relates to prioritized data backup using priority indicators associated with source data elements.

### BACKGROUND OF THE INVENTION

In conventional backup systems, different kinds of data are treated equally, independent of respective importance. More specifically, within a backup job, data elements are backed up serially according to a sequence such as, for example, by the order of node names. The sequence between different backup jobs is established according to a job schedule. Typically, backup jobs are allowed to run during a backup window, which may be, for example, non-business hours or another specified time period. Ideally, the backup jobs should finish within the backup window. Existing backup approaches may face a number of potential shortcomings.

Some potential shortcomings of existing backup approaches relate to organizational procedures of a backup job. For example, a user may need to carefully calculate and/or arrange backup jobs to ensure the backup jobs can finish within a given backup window. This task may extremely difficult such as, for example, when several different kinds of data require backing up, or when the backup window is relatively narrow.

Further potential shortcomings of existing backup approaches relate to backup windows. Particularly, backup jobs may require more time to finish than is allotted to the backup window. This need may arise under various circumstances such as an increase in total data to be backed up, network performance deficiencies, and/or network or backup source issues leading backup jobs to hang until timeout. When a backup job cannot finish within a backup window, the backup job may continue to run during business hours. This may lead to hampered performance of computing devices that include data being backed up as well as reduced performance of the backup job itself.

Inclusion of superfluous data in backup jobs may constitute additional potential shortcomings of existing backup approaches. Unimportant data such as, for example, ISO packages, temporary testing data, and/or other unimportant data may waste excessive amounts of backup time and/or storage media used to store backed up data. To illustrate, if unnecessary data is backed up toward the beginning of a backup job, important data may not be backed up within the backup window and/or storage media used to store backed up data may become full before the important data can be backed up.

### SUMMARY

One aspect of the invention relates to a prioritized backup system. The prioritized backup system may alleviate and/or eliminate various potential shortcomings of existing backup approaches by prioritizing data elements such that important data takes precedence over less important data during a backup procedure. More specifically, more important data may be backed up first, which may be especially advantageous in implementations where backup resources (e.g., storage media and/or network capacity) are limited. Backup procedures may run within a specified backup window to avoid adversely affecting performance of one or more elements associated with the prioritized backup system, while ensuring that at least the most important data is backed up. Even relatively unimportant data may be regularly backed up, although not necessarily during each backup procedure. The minimum frequency for which data is backed up may be adjusted such as by user specified settings.

Data to be backed up may include a plurality of data elements. Exemplary data elements may include one or more of volumes, partitions, clusters, files, and/or other units of data. Individual data elements may be assigned or associated with one or more local properties. Examples of local properties may include one or more of a base priority indicator, a current priority indicator, a priority increase factor, and/or other local properties. A base priority indicator associated with a given data element may convey the importance of that data element. In some implementations, a base priority indicator may be represented by a number, wherein the higher the number, the more important the associated data element. A current priority indicator associated with a given data element may convey the current importance of that data element. A current priority indicator associated with a given data element may be greater than or equal to a base priority indicator associated with the same data element. According to some implementations, a current priority indicator associated with a given data element may increase when that data element is not backed up. A priority increase factor associated with a given data element conveys how rapidly a current priority indicator associated with the same data element will increase when that data element is skipped (i.e., not backed up) during a backup procedure. For example, in some implementations, a current priority indicator will increase by a priority increase factor each time an associated data element is skipped during a backup procedure. A priority increase factor may impact the minimum frequency at which an associated data element is backed up.

Global settings may be established in an environment including the prioritized backup system. Examples of global setting may include one or more of a priority threshold, a backup window, an option to only backup essential data, and/or other global settings. The priority threshold may dictate that all data elements associated with a current priority indicator greater than or equal to the priority threshold will be backed up during a given backup procedure. It is noteworthy that the priority threshold may by any value including zero. The backup window may specify the time (e.g., time of day, day, date, and/or other timing indication) at which a given backup procedure is to run and/or the length of time allotted for that backup procedure to run. The option to only backup essential data may indicate whether only data elements associated with a current priority indicator greater than or equal to the priority threshold are to be backed up within the backup window, or whether as many data elements as possible should be backed up during the backup window.

The prioritized backup system may back up data originating at one or more remote data sources and/or one or more local data sources via a network. A remote data source and/or a local data source may include computing devices such as servers, clients, and/or other computing devices that store and/or process data. The remote data source may reside in a remote location relative to the prioritized backup system, whereas the local data source may reside in a similar location relative to the prioritized backup system. The network may facilitate communication of information and data between data sources (e.g., the remote data source and/or the local data source) and the prioritized backup system.

The prioritized backup system may include one or more of a user interface, an electronic storage, a processor, and/or other components. The user interface may be configured to provide an interface between the prioritized backup system and a user (e.g., an administrator of the prioritized backup system) through which the user may provide information to and/or receive information from the prioritized backup system. Exemplary information provided to and/or received from the prioritized backup system via the user interface may include one or more of local properties associated with individual data elements, global settings, and/or other information.

According to exemplary implementations, the electronic storage may include electronic storage media that electronically stores information, such as source data elements. The electronic storage media of the electronic storage may include one or both of system storage that is provided integrally (i.e., substantially non-removable) with the prioritized backup system and/or removable storage that is removably connectable to the prioritized backup system. The electronic storage may store software algorithms, information determined by the processor, information received via the user interface, and/or other information that enables the prioritized backup system to function as described herein.

The processor may be configured to provide information processing capabilities in the prioritized backup system. As such, the processor may be configured to execute one or more computer program modules. The one or more computer program modules may include one or more of a prioritization module, a sorting module, a backup module, a backup window module, and/or other modules.

The prioritization module may be configured to assign, adjust, and/or otherwise associate local properties (e.g., a base priority indicator, a current priority indicator, a priority increase factor, and/or other local properties) with individual source data elements. The user may manipulate local properties associated with individual source data elements or groups thereof via the user interface in conjunction with the prioritization module. In some implementations, the prioritization module may be configured to reset the current priority indicator associated with a given source data element equal to the base priority indicator associated with the given source data element responsive to the given source data element being backed up by the backup module. The prioritization module may be configured to increase the current priority indicator associated with a given source data element by a priority increase factor associated with the given source data element. Such an increase of a current priority indicator may be responsive to a determination by the backup module that source data elements associated with current priority indicators less than the priority threshold are not to be backed up.

The prioritization module may be configured to assign default local properties to source data elements that lack one or more associated local properties. In some implementations, a default base priority indicator may be equal to the priority threshold. A default priority increase factor may be equal to zero. The prioritization module may be configured to set and/or adjust global properties (e.g., a priority threshold, a backup window, an option to only backup essential data, and/or other global settings). Global properties may be manipulated by the user via the user interface in conjunction with the prioritization module.

The sorting module may be configured to sort source data elements. The source data elements may be sorted into an order based on current priority indicators associated with individual ones of the source data elements. According to some implementations, the order may include a list, index, and/or other record of source data elements to be backed up. As previously mentioned, a current priority indicator associated with a given source data element may be greater than or equal to a base priority indicator associated with the given source data element. The base priority indicator associated with the given source data element may relate to an importance of the given source data element.

Source data elements may be associated with one or more equal local properties (e.g., a base priority indicator, a current priority indicator, a priority increase factor, and/or other local properties). In exemplary implementations, the sorting module may be configured to sort source data elements associated with equal current priority indicators based on base priority indicators associated with individual ones of the source data elements. The sorting module may be configured to sort source data elements associated with equal current priority indicators and equal base priority indicators based on priority increase factors associated with individual ones of the source data elements. The sorting module may be configured to sort source data elements associated with equal current priority indicators, equal base priority indicators, and equal priority increase factors based on a default backup order. Such a default backup order may be specified by a user via the user interface. The default order may be based on one or more of file name, last-modified date, size, and/or other factors.

The backup module may be configured to back up source data elements. Backing up the source data elements may be performed according to the order provided the sorting module. Backing up the source data elements may include storing source data elements in the electronic storage. In some implementations, the backup module may be configured to back up only the source data elements associated with current priority indicators greater than or equal to the priority threshold. The backup module may be configured to determine whether source data elements associated with current priority indicators less than the priority threshold are to be backed up. An indication of whether source data elements associated with current priority indicators less than the priority threshold are to be backed up may be provided by the user via the user interface. The backup module may be configured to back up, according to the order provided by the sorting module, source data elements associated with current priority indicators less than the priority threshold until the remaining time in the backup window expires. The backup module may be configured to estimate a duration necessary to back up a given source data element.

The backup window module may be configured to determine information associated with a backup window. The backup window may be a time period in which source data elements can be backed up. In exemplary implementation, the backup window module may be configured to determine remaining time in the backup window. Such a determination may be responsive to a determination by the backup module that source data elements associated with current priority indicators less than the priority threshold are to be backed up. The backup window module may be configured to determine whether the remaining time in the backup window is greater than zero.

Another aspect of the invention relates to a method for providing a prioritized data backup. At one operation, source data elements may be sorted. The source data elements may be sorted into an order based on one or more of base priority indicators, current priority indicators, priority increase factors, and/or other local properties associated with individual ones of the source data elements. Prior to or concurrent with this operation, individual ones of source data elements may be assigned and/or associated with one or more local properties through execution of the prioritization module, manual entry by the user via the user interface, and/or other mechanisms for assigning and/or associating local properties with source data elements. According to exemplary implementations, this operation may be performed through execution of the sorting module.

At another operation, source data elements associated with current priority indicators greater than or equal to a priority threshold may be backed up. It is noteworthy that the priority threshold may be specified by the user via the user interface, and may by any value including zero. Such backing up may be performed according to the order provided by the sorting module. The backup module may be executed to perform this operation, in some implementations.

At another operation, the current priority indicators associated with source data elements backed up may be reset to equal the base priority indicators associated with those source data elements. This operation may be performed via execution of the prioritization module, in accordance with various implementations.

At another operation, a determination may be made as to whether source data elements associated with current priority indicators less than the priority threshold are to be backed up. This determination may be based on one or more global properties specified by the user via the user interface. For example, the user may specify via the user interface to back up source data elements associated with current priority indicator less than the priority threshold, provided there is time remaining in the backup window. The backup module may be executed to perform this operation.

At another operation, responsive to a determination that source data elements associated with current priority indicators less than the priority threshold are not to be backed up, the current priority indicator associated with yet-to-be-backed-up source data elements may be increased by associated priority increase factors. This operation may be performed through execution of the prioritization module.

At another operation, responsive to a determination that source data elements associated with current priority indicators less than the priority threshold are to be backed up, remaining time in a backup window may be determined. The backup window module may be executed to perform this operation.

At another operation, a determination may be made as to whether the remaining time in the backup window is greater that zero. This operation may be performed by the backup window module.

At another operation, responsive to a determination that the remaining time in the backup window is greater that zero, a determination may be made as to whether further source data elements are to be backed up. In exemplary implementations, such a determination may be based on the order provided though execution of the sorting module.

At another operation, responsive to a determination that further source data elements are to be backed up, a duration necessary to back up the yet-to-be-backed-up source data element having the greatest current priority indicator is estimated. This operation may be performed via execution of the backup module, in accordance with exemplary implementations.

At another operation, a determination may be made as to whether the estimated duration necessary to back up the yet-to-be-backed-up source data element having the greatest current priority indicator is less than the remaining time in the backup window. The backup window module may be executed to perform this operation.

At another operation, responsive to a determination that the estimated duration necessary to back up the yet-to-be-backed-up source data element having the greatest current priority indicator is not less than the remaining time in the backup window, the current priority indicator associated with that yet-to-be-backed-up source data element may be increased by the associated priority increase factor. This operation may be performed through execution of the prioritization module in some implementations.

At another operation, responsive to a determination that the estimated duration necessary to back up the yet-to-be-backed-up source data element having the greatest current priority indicator is less than the remaining time in the backup window, the yet-to-be-backed-up source data element having the greatest current priority indicator may be backed up. The backup module may be executed to perform this operation.

At another operation, the current priority indicator of the backed up source data element is reset to equal the base priority indicator associated with that source data element. This operation may be performed via execution of the prioritization module in some implementations.

These and other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an example of an environment in which implementations of the present invention may be practiced.

FIG. 2 illustrates an example of a method for providing a prioritized data backup.

### DETAILED DESCRIPTION OF THE INVENTION

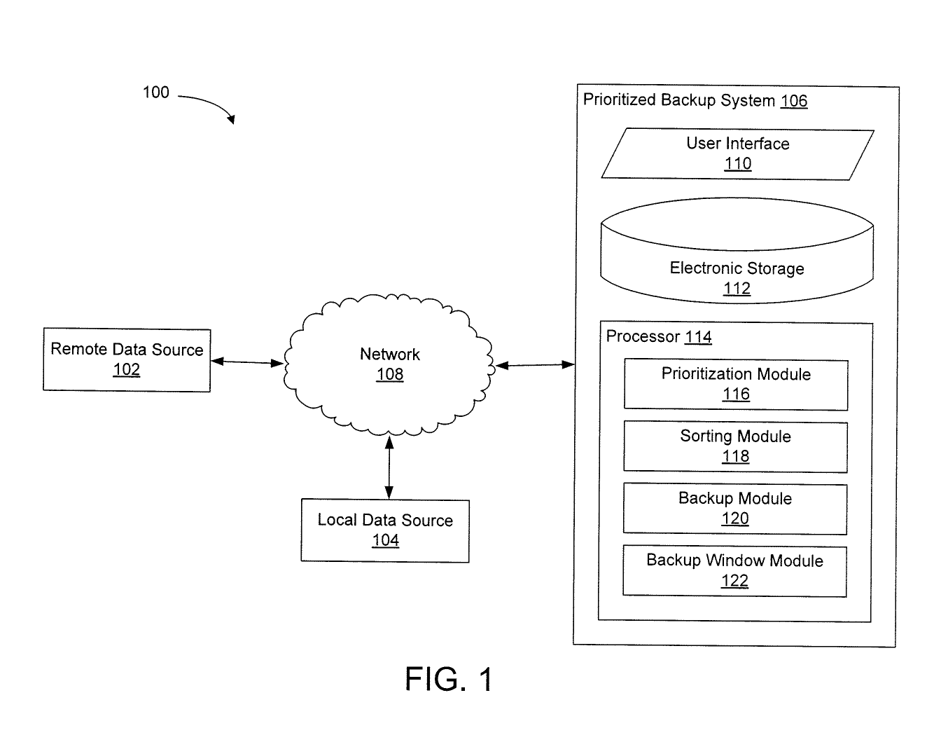

FIG. 1 illustrates an example of an environment 100 in which implementations of the present invention may be practiced. Implementations of the present invention may alleviate and/or eliminate various potential shortcomings of existing backup approaches by prioritizing data elements such that important data takes precedence over less important data during a backup procedure. More specifically, more important data may be backed up first, which may be especially advantageous in implementations where backup resources (e.g., storage media and/or network capacity) are limited. Backup procedures may run within a specified backup window to avoid adversely affecting performance of one or more elements of the environment 100, while ensuring that at least the most important data is backed up. Even relatively unimportant data may be regularly backed up, although not necessarily during each backup procedure. The minimum frequency for which data is backed up may be adjusted such as by user specified settings.

Data to be backed up may include a plurality of data elements. Exemplary data elements may include one or more of volumes, partitions, clusters, files, and/or other units of data. Individual data elements may be assigned or associated with one or more local properties. Examples of local properties may include one or more of a base priority indicator, a current priority indicator, a priority increase factor, and/or other local properties. A base priority indicator associated with a given data element may convey the importance of that data element. In some implementations, a base priority indicator may be represented by a number, wherein the higher the number, the more important the associated data element. A current priority indicator associated with a given data element may convey the current importance of that data element. A current priority indicator associated with a given data element may be greater than or equal to a base priority indicator associated with the same data element. According to some implementations, a current priority indicator associated with a given data element may increase when that data element is not backed up. A priority increase factor associated with a given data element conveys how rapidly a current priority indicator associated with the same data element will increase when that data element is skipped (i.e., not backed up) during a backup procedure. For example, in some implementations, a current priority indicator will increase by a priority increase factor each time an associated data element is skipped during a backup procedure. A priority increase factor may impact the minimum frequency at which an associated data element is backed up.

Global settings may be established in the environment 100. Examples of global setting may include one or more of a priority threshold, a backup window, an option to only backup essential data, and/or other global settings. The priority threshold may dictate that all data elements associated with a current priority indicator greater than or equal to the priority threshold will be backed up during a given backup procedure. It is noteworthy that the priority threshold may by any value including zero. The backup window may specify the time (e.g., time of day, day, date, and/or other timing indication) at which a given backup procedure is to run and/or the length of time allotted for that backup procedure to run. The option to only backup essential data may indicate whether only data elements associated with a current priority indicator greater than or equal to the priority threshold are to be backed up within the backup window, or whether as many data elements as possible should be backed up during the backup window.

The environment 100 may include various data sources such as one or more of a remote data source 102 and/or a local data source 104. A prioritized backup system 106 may back up data originating at the remote data source 102 and/or the local data source 104 via a network 108. Although single instances of the remote data source 102 and the local data source 104 are depicted in FIG. 1, it is appreciated that the environment 100 may include any number of data sources similar to the remote data source 102 and/or the local data source 104. The remote data source 102 and/or the local data source 104 may include computing devices such as servers, clients, and/or other computing devices that store and/or process data. The remote data source 102 may reside in a remote location relative to the prioritized backup system 106, whereas the local data source 104 may reside in a similar location relative to the prioritized backup system 106. The network 108 may facilitate communication of information and data between data sources (e.g., the remote data source 102 and/or the local data source 104) and the prioritized backup system 106. The network 108 may include the Internet and/or other networks. It will be appreciated that this is not intended to be limiting, and that the scope of this disclosure includes implementations in which data sources (e.g., the remote data source 102 and/or the local data source 104) and the prioritized backup system 106 are operatively linked via some other communication media.

The prioritized backup system 106 may include one or more of a user interface 110, an electronic storage 112, a processor 114, and/or other components. The user interface 110 may be configured to provide an interface between the prioritized backup system 106 and a user (e.g., an administrator of the prioritized backup system 106) through which the user may provide information to and/or receive information from the prioritized backup system 106. This enables data, results, and/or instructions and any other communicable items, collectively referred to as “information,” to be communicated between the user and the prioritized backup system 106. Exemplary information provided to and/or received from the prioritized backup system 106 via the user interface 110 may include one or more of local properties associated with individual data elements, global settings for the environment 100, and/or other information. Examples of interface devices suitable for inclusion in the user interface 110 include one or more of a keypad, buttons, switches, a keyboard, knobs, levers, a display screen, a touch screen, speakers, a microphone, an indicator light, an audible alarm, and/or a printer.

It is to be understood that other communication techniques, either hard-wired or wireless, are also contemplated by the present invention as the user interface 110. For example, the present invention contemplates that the user interface 110 may be integrated with a removable storage interface provided by the electronic storage 112. In this example, information may be loaded into the user interface 110 from removable storage (e.g., a smart card, a flash drive, a removable disk, etc.) that enables the user(s) to customize the implementation of the user interface 110. Other exemplary input devices and techniques adapted for use with the prioritized backup system 106 as the user interface 110 include, but are not limited to, an RS-232 port, RF link, an IR link, modem (telephone, cable or other). In short, any technique for communicating information with the prioritized backup system 106 is contemplated by the present invention as the user interface 110.

According to exemplary implementations, the electronic storage 112 may include electronic storage media that electronically stores information, such as source data elements. The electronic storage media of the electronic storage 112 may include one or both of system storage that is provided integrally (i.e., substantially non-removable) with the prioritized backup system 106 and/or removable storage that is removably connectable to the prioritized backup system 106 via, for example, a port (e.g., a USB port, a firewire port, etc.) or a drive (e.g., a disk drive, etc.). The electronic storage 112 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 112 may store software algorithms, information determined by the processor 114, information received via the user interface 110, and/or other information that enables the prioritized backup system 106 to function as described herein. The electronic storage 112 may be a separate component within the prioritized backup system 106. The electronic storage 112 may be included in a backup environment such as, for example, a storage area network (SAN).

The processor 114 may be configured to provide information processing capabilities in the prioritized backup system 106. As such, the processor 114 may include one or more of a digital processor, an analog processor, a digital circuit designed to process information, an analog circuit designed to process information, a state machine, and/or other mechanisms for electronically processing information. Although the processor 114 is shown in FIG. 1 as a single entity, this is for illustrative purposes only. In some implementations, the processor 114 may include a plurality of processing units. These processing units may be physically located within the same device, or the processor 114 may represent processing functionality of a plurality of devices operating in coordination.

As is shown in FIG. 1, the processor 114 may be configured to execute one or more computer program modules. The one or more computer program modules may include one or more of a prioritization module 116, a sorting module 118, a backup module 120, a backup window module 122, and/or other modules. The processor 114 may be configured to execute modules 116, 118, 120, and/or 122 by software; hardware; firmware; some combination of software, hardware, and/or firmware; and/or other mechanisms for configuring processing capabilities on the processor 114.

It should be appreciated that although modules 116, 118, 120, and 122 are illustrated in FIG. 1 as being co-located within a single processing unit, in implementations in which the processor 114 includes multiple processing units, one or more of the modules 116, 118, 120, and/or 122 may be located remotely from the other modules. The description of the functionality provided by the different modules 116, 118, 120, and/or 122 described below is for illustrative purposes, and is not intended to be limiting, as any of modules 116, 118, 120, and/or 122 may provide more or less functionality than is described. For example, one or more of the modules 116, 118, 120, and/or 122 may be eliminated, and some or all of its functionality may be provided by other ones of the modules 116, 118, 120, and/or 122. As another example, the processor 114 may be configured to execute one or more additional modules that may perform some or all of the functionality attributed below to one of the modules 116, 118, 120, and/or 122.

The prioritization module 116 may be configured to assign, adjust, and/or otherwise associate local properties (e.g., a base priority indicator, a current priority indicator, a priority increase factor, and/or other local properties) with individual source data elements. The user may manipulate local properties associated with individual source data elements or groups thereof via the user interface 110 in conjunction with the prioritization module 116. In some implementations, the prioritization module 116 may be configured to reset the current priority indicator associated with a given source data element equal to the base priority indicator associated with the given source data element responsive to the given source data element being backed up by the backup module 120. The prioritization module 116 may be configured to increase the current priority indicator associated with a given source data element by a priority increase factor associated with the given source data element. Such an increase of a current priority indicator may be responsive to a determination by the backup module 120 that source data elements associated with current priority indicators less than the priority threshold are not to be backed up.

The prioritization module 116 may be configured to assign default local properties to source data elements that lack one or more associated local properties. In some implementations, a default base priority indicator may be equal to the priority threshold. A default priority increase factor may be equal to zero. The prioritization module 116 may be configured to set and/or adjust global properties (e.g., a priority threshold, a backup window, an option to only backup essential data, and/or other global settings) associated with the environment 100. Global properties may be manipulated by the user via the user interface 110 in conjunction with the prioritization module 116.

The sorting module 118 may be configured to sort source data elements. The source data elements may be sorted into an order based on current priority indicators associated with individual ones of the source data elements. According to some implementations, the order may include a list, index, and/or other record of source data elements to be backed up. As previously mentioned, a current priority indicator associated with a given source data element may be greater than or equal to a base priority indicator associated with the given source data element. The base priority indicator associated with the given source data element may relate to an importance of the given source data element.

Source data elements may be associated with one or more equal local properties (e.g., a base priority indicator, a current priority indicator, a priority increase factor, and/or other local properties). In exemplary implementations, the sorting module 118 may be configured to sort source data elements associated with equal current priority indicators based on base priority indicators associated with individual ones of the source data elements. The sorting module 118 may be configured to sort source data elements associated with equal current priority indicators and equal base priority indicators based on priority increase factors associated with individual ones of the source data elements. The sorting module 118 may be configured to sort source data elements associated with equal current priority indicators, equal base priority indicators, and equal priority increase factors based on a default backup order. Such a default backup order may be specified by a user via the user interface 110. The default order may be based on one or more of file name, last-modified date, size, and/or other factors.

The backup module 120 may be configured to back up source data elements. Backing up the source data elements may be performed according to the order provided the sorting module 118. Backing up the source data elements may include storing source data elements in the electronic storage 112. In some implementations, the backup module 120 may be configured to back up only the source data elements associated with current priority indicators greater than or equal to the priority threshold. The backup module 120 may be configured to determine whether source data elements associated with current priority indicators less than the priority threshold are to be backed up. An indication of whether source data elements associated with current priority indicators less than the priority threshold are to be backed up may be provided by the user via the user interface 110. The backup module 120 may be configured to back up, according to the order provided by the sorting module 118, source data elements associated with current priority indicators less than the priority threshold until the remaining time in the backup window expires. The backup module 120 may be configured to estimate a duration necessary to back up a given source data element.

The backup window module 122 may be configured to determine information associated with a backup window. The backup window may be a time period in which source data elements can be backed up. In exemplary implementation, the backup window module 122 may be configured to determine remaining time in the backup window. Such a determination may be responsive to a determination by the backup module 120 that source data elements associated with current priority indicators less than the priority threshold are to be backed up. The backup window module 122 may be configured to determine whether the remaining time in the backup window is greater than zero.

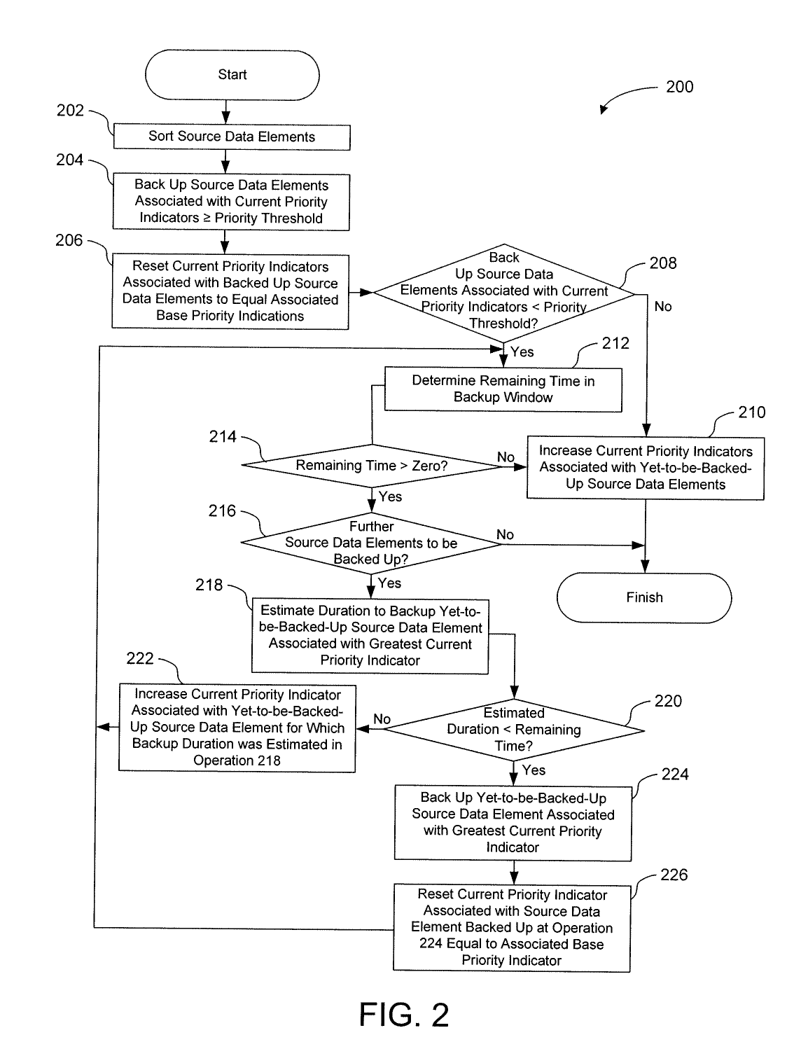

FIG. 2 illustrates an exemplary method 200 for providing a prioritized data backup. The operations of the method 200 presented below are intended to be illustrative. In some implementations, the method 200 may be accomplished with one or more additional operations not described, and/or without one or more of the operations discussed. Additionally, the order in which the operations of the method 200 are illustrated in FIG. 2 and described below is not intended to be limiting.

In some implementations, the method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 200 in response to instructions stored electronically on a tangible electronic storage medium. The one or more processing devices may include one or more devices configured through hardware, firmware, and/or software to be specifically designed for execution of one or more of the operations of the method 200.

At an operation 202, source data elements may be sorted. The source data elements may be sorted into an order based on one or more of base priority indicators, current priority indicators, priority increase factors, and/or other local properties associated with individual ones of the source data elements. Prior to or concurrent with the operation 202, individual ones of source data elements may be assigned and/or associated with one or more local properties through execution of the prioritization module 116, manual entry by the user via the user interface 110, and/or other mechanisms for assigning and/or associating local properties with source data elements. According to exemplary implementations, the operation 202 may be performed through execution of the sorting module 118.

At an operation 204, source data elements associated with current priority indicators greater than or equal to a priority threshold may be backed up. It is noteworthy that the priority threshold may be specified by the user via the user interface 110, and may by any value including zero. Such backing up may be performed according to the order provided by the sorting module 118. The backup module 120 may be executed to perform the operation 204, in some implementations.

At an operation 206, the current priority indicators associated with source data elements backed up at the operation 204 may be reset to equal the base priority indicators associated with those source data elements. The operation 206 may be performed via execution of the prioritization module 116, in accordance with various implementations.

At an operation 208, a determination may be made as to whether source data elements associated with current priority indicators less than the priority threshold are to be backed up. This determination may be based on one or more global properties specified by the user via the user interface 110. For example, the user may specify via the user interface 110 to back up source data elements associated with current priority indicator less than the priority threshold, provided there is time remaining in the backup window. Responsive to a negative determination, the process flow of the method 200 may proceed from the operation 208 to an operation 210. Responsive to an affirmative determination, the process flow of the method 200 may proceed from the operation 208 to an operation 212. The backup module 120 may be executed to perform the operation 208.

At the operation 210, the current priority indicator associated with yet-to-be-backed-up source data elements may be increased by associated priority increase factors. The operation 210 may be performed through execution of the prioritization module 116.

At the operation 212, remaining time in a backup window may be determined responsive to a determination at the operation 208 that source data elements associated with current priority indicators less than the priority threshold are to be backed up. The backup window module 122 may be executed to perform the operation 212.

At an operation 214, a determination may be made as to whether the remaining time in the backup window is greater that zero. Responsive to a negative determination, the process flow of the method 200 may proceed from the operation 214 to the operation 210. Responsive to an affirmative determination, the process flow of the method 200 may proceed from the operation 214 to an operation 216. The operation 214 may be performed by the backup window module 122.

At the operation 216, a determination may be made as to whether further source data elements are to be backed up. In exemplary implementations, such a determination may be based on the order provided though execution of the sorting module 118.

At an operation 218, a duration necessary to back up the yet-to-be-backed-up source data element having the greatest current priority indicator is estimated. The operation 218 may be performed via execution of the backup module 120, in accordance with exemplary implementations.

At an operation 220, a determination may be made as to whether the estimated duration necessary to back up the yet-to-be-backed-up source data element having the greatest current priority indicator (see the operation 218) is less than the remaining time in the backup window (see the operation 212). Responsive to a negative determination, the process flow of the method 200 may proceed from the operation 220 to the operation 222. Responsive to an affirmative determination, the process flow of the method 200 may proceed from the operation 220 to an operation 224. The backup window module 122 may be executed to perform the operation 220.

At the operation 222, responsive to a negative determination at the operation 220, the current priority indicator associated with the yet-to-be-backed-up source data element for which the backup duration was estimated in the operation 218 may be increased by the associated priority increase factor. The process flow of the method 200 may proceed from the operation 222 to the operation 212. The operation 222 may be performed through execution of the prioritization module 116 in some implementations.

At the operation 224, the yet-to-be-backed-up source data element having the greatest current priority indicator may be backed up. The backup module 120 may be executed to perform the operation 224.

At an operation 226, the current priority indicator of the source data element backed up at the operation 224 is reset to equal the base priority indicator associated with that source data element. The process flow of the method 200 may proceed from the operation 226 to the operation 212. The operation 226 may be performed via execution of the prioritization module 116 in some implementations.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A method for providing a prioritized data backup, the method comprising:
sorting source data elements into an order based on current priority indicators associated with individual ones of the source data elements; and
backing up, according to the order, source data elements associated with current priority indicators greater than or equal to a priority threshold.

2. The method of claim 1, wherein a current priority indicator associated with a given source data element is greater than or equal to a base priority indicator associated with the given source data element, the base priority indicator associated with the given source data element relating to an importance of the given source data element.

3. The method of claim 2, wherein the current priority indicator associated with the given source data element is reset to equal the base priority indicator associated with the given source data element responsive to the given source data element being backed up.

4. The method of claim 1, further comprising determining whether source data elements associated with current priority indicators less than the priority threshold are to be backed up.

5. The method of claim 4, further comprising increasing the current priority indicator associated with a given source data element by a priority increase factor associated with the given source data element responsive to a determination that source data elements associated with current priority indicators less than the priority threshold are not to be backed up.

6. The method of claim 4, further comprising determining remaining time in a backup window responsive to a determination that source data elements associated with current priority indicators less than the priority threshold are to be backed up, wherein the backup window is a time period in which source data elements can be backed up.

7. The method of claim 6, further comprising backing up, according to the order, source data elements associated with current priority indicators less than the priority threshold until the remaining time in the backup window expires.

8. The method of claim 6, further comprising estimating a duration necessary to back up a given source data element.

9. The method of claim 8, further comprising backing up the given source data element responsive to the duration necessary to back up the given source data element being less that the remaining time in the backup window.

10. The method of claim 1, wherein source data elements associated with equal current priority indicators are sorted based on base priority indicators associated with individual ones of the source data elements, the base priority indicator associated with a given source data element relating to an importance of the given source data element.

11. The method of claim 10, wherein source data elements associated with equal current priority indicators and equal base priority indicators are sorted based on priority increase factors associated with individual ones of the source data elements.

12. The method of claim 11, wherein source data elements associated with equal current priority indicators, equal base priority indicators, and equal priority increase factors are sorted based on a default backup order.

13. A system for providing a prioritized data backup, the system comprising:
one or more processors configured to execute computer program modules, the computer program modules comprising:
a sorting module configured to sort source data elements into an order based on current priority indicators associated with individual ones of the source data elements; and
a backup module configured to back up, according to the order provided the sorting module, source data elements associated with current priority indicators greater than or equal to a priority threshold.

14. The system of claim 13, wherein a current priority indicator associated with a given source data element is greater than or equal to a base priority indicator associated with the given source data element, the base priority indicator associated with the given source data element relating to an importance of the given source data element.

15. The system of claim 14, wherein the computer program modules further comprise a prioritization module configured to reset the current priority indicator associated with the given source data element equal to the base priority indicator associated with the given source data element responsive to the given source data element being backed up by the backup module.

16. The system of claim 13, wherein the backup module is further configured to determine whether source data elements associated with current priority indicators less than the priority threshold are to be backed up.

17. The system of claim 16, wherein the computer program modules further comprise a prioritization module configured to increase the current priority indicator associated with a given source data element by a priority increase factor associated with the given source data element responsive to a determination by the backup module that source data elements associated with current priority indicators less than the priority threshold are not to be backed up.

18. The system of claim 16, wherein the computer program modules further comprise a backup window module configured to determine remaining time in a backup window responsive to a determination by the backup module that source data elements associated with current priority indicators less than the priority threshold are to be backed up, wherein the backup window is a time period in which source data elements can be backed up.

19. The system of claim 18, wherein the backup module is further configured to back up, according to the order provided by the sorting module, source data elements associated with current priority indicators less than the priority threshold until the remaining time in the backup window expires.

20. The system of claim 13, wherein the sorting module is further configured to:
sort source data elements associated with equal current priority indicators based on base priority indicators associated with individual ones of the source data elements, the base priority indicator associated with a given source data element relating to an importance of the given source data element;
sort source data elements associated with equal current priority indicators and equal base priority indicators based on priority increase factors associated with individual ones of the source data elements; and
sort source data elements associated with equal current priority indicators, equal base priority indicators, and equal priority increase factors based on a default backup order.

21. A system for providing a prioritized data backup, the system comprising:
a prioritized backup system communicatively couple with at least one data source storing a plurality of source data elements, the prioritized backup system comprising one or more processors configured to execute computer program modules, the computer program modules comprising:
a prioritization module configured to associate one or more properties with individual ones of the source data elements, the local properties associated with a given source data element including at least a priority indicator;
a sorting module configured to sort the plurality of source data elements into an order based on the priority indicators associated with individual ones of the source data elements; and
a backup module configured to back up, according to the order provided the sorting module, source data elements associated with current priority indicators greater than or equal to a priority threshold.
